(19) United States
(12) Patent Application Publication
(10) Pub. No.: US 2024/0053225 A1
(43) Pub. Date: Feb. 15, 2024

(54) Method and Apparatus for Identifying an Abnormality in Mechanical Apparatus or Mechanical Component

(71) Applicant: Robert Bosch GmbH, Stuttgart (DE)

(72) Inventors: Shi Deng, Shanghai (CN); Mingang Wang, Shanghai (CN)

(21) Appl. No.: 18/260,385

(22) PCT Filed: Jan. 6, 2021
(86) PCT No.: PCT/CN2021/070457

§ 371 Date: Jul. 5, 2023

(51) Int. Cl. G01M 13/00; G05B 23/02

(52) U.S. Cl. CPC G01M 13/00; G05B 23/0254

(57) ABSTRACT

A method for identifying an abnormality in a mechanical apparatus or mechanical component includes: i) acquiring at least two classes of undersampled measurement data collected in or on a mechanical apparatus or mechanical component, all of the at least two classes of undersampled measurement data being different from one another in either one of or both of the following aspects: delay relative to occurrence time of a trigger event, and sampling frequency; and ii) based on the at least two classes of undersampled measurement data acquired, using an abnormality identification model to identify an abnormality in the mechanical apparatus or mechanical component, the abnormality identification model being based on machine learning and used for identifying an abnormality in the mechanical apparatus or mechanical component. Also disclosed is a method for training an abnormality identification model based on machine learning, a computer apparatus, a computer program product, and a detection apparatus. The above provides a fault diagnosis or predictive maintenance solution which is cost-effective and gives reliable results.

### TECHNICAL FIELD

The present invention relates to a method for identifying an abnormality in a mechanical apparatus or mechanical component. The present invention further relates to a method for training an abnormality identification model based on machine learning, to a corresponding computer apparatus, to a corresponding computer program product, to a corresponding detection apparatus and to a corresponding mechanical apparatus or mechanical component.

### BACKGROUND ART

Fault diagnosis or predictive maintenance of mechanical components in electric drive systems, i.e. electric machines and gearboxes, is intended to identify signals representing actually present or potential mechanical faults of mechanical components such as bearings, rotors, drive shafts, flanges, rims, housings, bolts and gears, etc. Such signals might indicate acceleration, displacement, rotation, inertia, voltage or current.

However, existing fault diagnosis or predictive maintenance solutions often rely on high sampling frequency signals. However, high sampling frequencies will not only increase the complexity and cost of sampling apparatuses, processing apparatuses and communication apparatuses, but will also increase the vehicle cost, which is not desirable with increasingly fierce price competition in the vehicle market. On the other hand, if low sampling frequency signals are used in existing fault diagnosis or predictive maintenance solutions, they will lead to unreliable diagnosis results, because the expression of defects or faults in low sampling frequency signals is fuzzy and inconspicuous due to aliasing.

Thus, it is hoped to provide a fault diagnosis or predictive maintenance solution which is cost-effective and gives reliable results.

### SUMMARY OF THE INVENTION

The objective of the present invention is achieved through a method for identifying an abnormality in a mechanical apparatus or mechanical component, the method at least comprising the following steps:
i) acquiring at least two classes of undersampled measurement data collected in or on a mechanical apparatus or mechanical component, all of the at least two classes of undersampled measurement data being different from one another in either one of or both of the following aspects: delay Δt relative to occurrence time t₀ of a trigger event, and sampling frequency and
ii) based on the at least two classes of undersampled measurement data acquired, using an abnormality identification model to identify an abnormality in the mechanical apparatus or mechanical component, the abnormality identification model being based on machine learning and used for identifying an abnormality in the mechanical apparatus or mechanical component.

According to an optional embodiment of the present invention, step ii) comprises:
a) subjecting the at least two classes of undersampled measurement data to characteristic extraction separately;
b) inputting an extracted characteristic into a trained abnormality identification model based on a classification algorithm, to obtain an abnormality identification result for the mechanical apparatus or mechanical component.

According to an optional embodiment of the present invention, step ii) comprises: inputting the at least two classes of undersampled measurement data into a trained abnormality identification model based on deep learning, to obtain an abnormality identification result for the mechanical apparatus or mechanical component.

According to an optional embodiment of the present invention, the at least two classes of undersampled measurement data are collected with the aid of a single sensor by: causing the single sensor to begin signal collection at at least two different delays Δt relative to an occurrence time t₀ of a trigger event, and/or causing the single sensor to collect a signal at different undersampling frequencies fₛ.

According to an optional embodiment of the present invention, the at least two classes of undersampled measurement data are collected with the aid of at least two sensors by: causing the at least two sensors to begin signal collection at different delays Δt relative to an occurrence time t₀ of a trigger event, and/or causing the at least two sensors to collect a signal at different undersampling frequencies fₛ.

According to an optional embodiment of the present invention, the following is performed before step ii): separately dividing the at least two classes of undersampled measurement data acquired into multiple samples, wherein there is a time overlap between samples that are adjacent to each other in time, and wherein in step ii), each sample is subjected to characteristic extraction separately or each sample is inputted into an abnormality identification model based on deep learning.

In another aspect, the objective of the present invention is further achieved through a method for training an abnormality identification model based on machine learning, the abnormality identification model being used to identify an abnormality in a mechanical apparatus or mechanical component, the method at least comprising the following steps:
i′) acquiring at least two classes of undersampled measurement data collected in or on a mechanical apparatus or mechanical component, all of the at least two classes of undersampled measurement data being different from one another in either one of or both of the following aspects: delay Δt relative to occurrence time t₀ of a trigger event, and sampling frequency fₛ, and
ii′) training an abnormality identification model on the basis of the at least two classes of undersampled measurement data acquired.

In another aspect, the objective of the present invention is further achieved through a computer apparatus, comprising a processor and a computer-readable storage medium communicatively connected to the processor, the computer-readable storage medium having a computer instruction stored therein, wherein a step of the method as described above is realized when the computer instruction is executed by the processor.

In another aspect, the objective of the present invention is further achieved through a computer program product, comprising a computer instruction, wherein a step of the method as described above is realized when the computer instruction is executed by a processor.

In another aspect, the objective of the present invention is further achieved through a detection apparatus, the detection apparatus being disposed in or on a mechanical apparatus or mechanical component for the purpose of collecting measurement data at an undersampling frequency, the measurement data representing an operating status of the mechanical apparatus or mechanical component, wherein the detection apparatus comprises a single sensor, the sensor being configured to begin signal collection at a variable delay Δt in response to a trigger event, and/or configured to have a variable undersampling frequency fₛ; or the detection apparatus comprises at least two sensors, a first sensor of the at least two sensors being configured to begin signal collection at a first delay Δt₁ in response to a trigger event, and a second sensor being configured to begin signal collection at a second delay Δt₂ different from the first delay Δt₁ in response to a trigger event; and/or the first sensor being configured to have a first undersampling frequency fₛ₁, and the second sensor being configured to have a second undersampling frequency fₛ₂ different from the first undersampling frequency fₛ₁.

According to an optional embodiment, the detection apparatus is communicatively connected to the computer apparatus described above or the processor thereof.

In another aspect, the objective of the present invention is achieved through a mechanical apparatus or mechanical component, comprising the detection apparatus described above.

The present invention has the following advantages:
It only uses one or more sensors having a low sampling frequency, wherein a sensor with a low sampling frequency has a significant cost advantage over sensors with high sampling frequencies which are relied on by existing fault diagnosis or predictive maintenance methods.
The apparatuses, for example the sensors, have low performance and only a small amount of data, and therefore do not need to be equipped with complex computing modules and/or power sources with high energy consumption; this reduces the complexity, volume and energy consumption of these apparatuses.

Other advantages and advantageous embodiments of the subject matter of the present invention are obvious from the description, drawings and claims.

### BRIEF DESCRIPTION OF THE DRAWINGS

Further features and advantages of the present invention can be further expounded through the following detailed description of particular embodiments with reference to the drawings. The drawings are as follows:

FIG. 1 shows a structural block diagram of an apparatus for identifying an abnormality in a mechanical apparatus or mechanical component according to an exemplary embodiment of the present invention.

FIG. 2 shows a flow chart of a method according to an exemplary embodiment of the present invention for training an abnormality identification model that is based on machine learning and used to identify an abnormality in a mechanical apparatus or mechanical component.

FIGS. 3A and 3B respectively show a time domain graph and a frequency domain graph of a vibration signal collected from a healthy rotary member at a high sampling frequency meeting the requirements of the sampling theorem.

FIGS. 4A and 4B respectively show a time domain graph and a frequency domain graph of a vibration signal collected from an abnormal rotary member at the same sampling frequency as in FIGS. 3A and 3B.

FIGS. 5A and 5B respectively show a time domain graph and a frequency domain graph of a vibration signal collected from the healthy rotary member at an undersampling frequency equal to 1/11 of the sampling frequency in FIGS. 3-4.

FIGS. 6A and 6B respectively show a time domain graph and a frequency domain graph of a signal collected from the abnormal rotary member at the same undersampling frequency as in FIGS. 5A and 5B.

FIGS. 7A and 7B respectively show a time domain graph and a frequency domain graph of a vibration signal collected from the healthy rotary member at an undersampling frequency equal to 1/17 of the sampling frequency in FIGS. 3-4.

FIGS. 8A and 8B respectively show a time domain graph and a frequency domain graph of a signal collected from the abnormal rotary member at the same undersampling frequency as in FIGS. 7A and 7B.

FIG. 9A shows a time domain graph of a signal collected from a healthy mechanical component, with two sets of undersampled measurement data having different delays marked thereon.

FIG. 9B shows a time domain graph of a signal collected from an abnormal mechanical component, with two sets of undersampled measurement data having different delays marked thereon.

FIG. 9C shows a time domain graph of a signal collected from an abnormal mechanical component, with two sets of undersampled measurement data having different sampling frequencies marked thereon.

FIG. 10 shows a flow chart of one step of a method according to the present invention for training an abnormality identification model; and

FIG. 11 shows a flow chart of a method according to an exemplary embodiment of the present invention for identifying an abnormality in a mechanical apparatus or mechanical component.

### DETAILED DESCRIPTION OF THE INVENTION

To clarify the technical problem to be solved by the present invention as well as the technical solution and beneficial technical effects thereof, the present invention is explained in further detail below with reference to the drawings and several exemplary embodiments. It should be understood that the particular embodiments described here are merely used to explain the present invention, not to limit the scope of protection thereof. In the drawings, identical or similar reference labels denote identical or equivalent components.

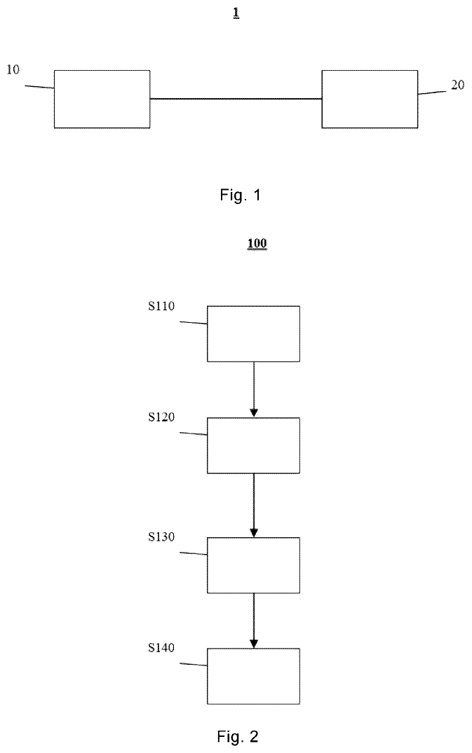

FIG. 1 shows a structural block diagram of an apparatus 1 for identifying an abnormality in a mechanical apparatus or mechanical component according to an exemplary embodiment of the present invention. The mechanical apparatus may broadly comprise various types of mechanical apparatus, such as an electric machine and a gearbox in a drive system, in particular a vehicle drive system. The mechanical component may broadly comprise various types of mechanical component, such as bolts, housings, flanges, rims, bearings (e.g. rolling bearings) and rotary members (e.g. rotors, drive shafts, gears or similar) used in electric machines and gearboxes, and so on.

As used herein, the term “abnormality” should be broadly understood to mean any abnormal phenomenon that arises in a mechanical apparatus or mechanical component and causes reduction or degradation of a function and/or the efficiency of the mechanical apparatus or mechanical component itself or a device in which it is located. This not only includes faults or defects that arise in the mechanical apparatus or mechanical component and have already caused a function and/or characteristic of the mechanical apparatus or mechanical component itself or the device in which it is located to deviate from a normal range, but also includes “sub-health” issues that arise in the mechanical apparatus or mechanical component and cause the function and/or efficiency of the mechanical apparatus or mechanical component itself or the device in which it is located to decrease, without deviating from the normal range.

When applied to a mechanical apparatus, the apparatus 1 is able to identify an abnormality of at least one component in the mechanical apparatus. When applied to a mechanical component, the apparatus 1 is able to identify at least one abnormality in the mechanical component.

The apparatus 1 comprises a processor 10 and a computer-readable storage medium 20 communicatively connected to the processor 10. Computer instructions are stored in the computer-readable storage medium 20, and when the computer instructions are executed by the processor 10, steps of a method 100 and/or 200 according to the present invention are realized; the method will be described in detail below.

Furthermore, a detection apparatus is disposed in or on the mechanical apparatus or mechanical component, and used to collect measurement data representing the operating status of the mechanical apparatus or mechanical component, e.g. vibration signals, torque signals, acceleration signals, displacement signals, inertia signals, rotation signals, or electrical signals such as voltage signals and current signals. The measurement data collected by the detection apparatus may be acquired by the apparatus 1 to serve as training samples for training an abnormality identification model (see the description below) or to serve as detection data for analysing and assessing abnormalities in the mechanical apparatus or mechanical component.

In one example, when monitoring damage to bearing rollers in an electric machine and/or eccentricity of a drive shaft with the aid of the apparatus 1, a vibration sensor (e.g. a vibration acceleration sensor) may be arranged on a housing of the electric machine as the detection apparatus, in order to capture vibration signals of the electric machine, the vibration signals being acquired by the apparatus 1 to perform abnormality identification. In another example, when monitoring degradation of bearing lubrication with the aid of the apparatus 1, a current sensor and/or voltage sensor may be used as the detection apparatus to detect current and/or voltage signals in an inverter, the current and/or voltage signals being acquired by the apparatus 1 to perform abnormality identification.

In one example, the apparatus 1 may be configured as a remote server, and the detection apparatus is disposed in or on a vehicle. In another example, both the apparatus 1 and the detection apparatus are disposed in or on a vehicle.

FIG. 2 shows a flow chart of a method 100 according to an exemplary embodiment of the present invention for training an abnormality identification model that is based on machine learning and used to identify an abnormality in a mechanical apparatus or mechanical component.

In step S110, at least two classes of undersampled measurement data collected in or on a mechanical apparatus or mechanical component by a detection apparatus for example are acquired, wherein all of the at least two classes of undersampled measurement data are different from one another in either one of or both of the following aspects: delay relative to occurrence time of a trigger event, and sampling frequency.

“Undersampling” may be understood to mean that a sampling frequency used when sampling is insufficient, i.e. does not meet the requirements of the sampling theorem, so that aliasing occurs in the collected signals. In general, the sampling frequency of undersampling may be a frequency lower than twice the signal frequency, because in this case aliasing will occur in which high frequencies are aliased as low frequencies.

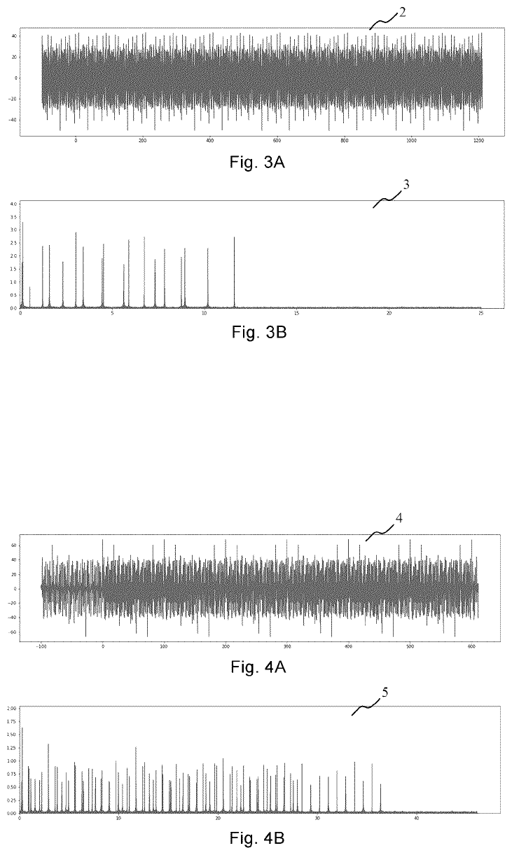

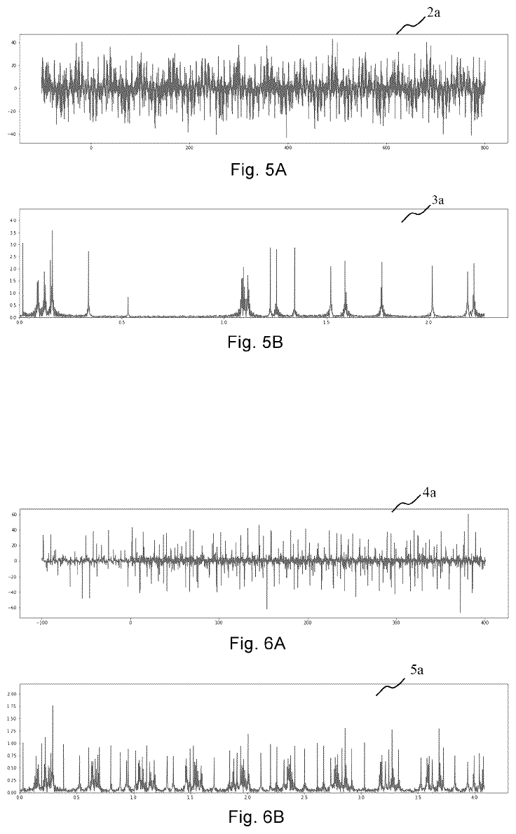

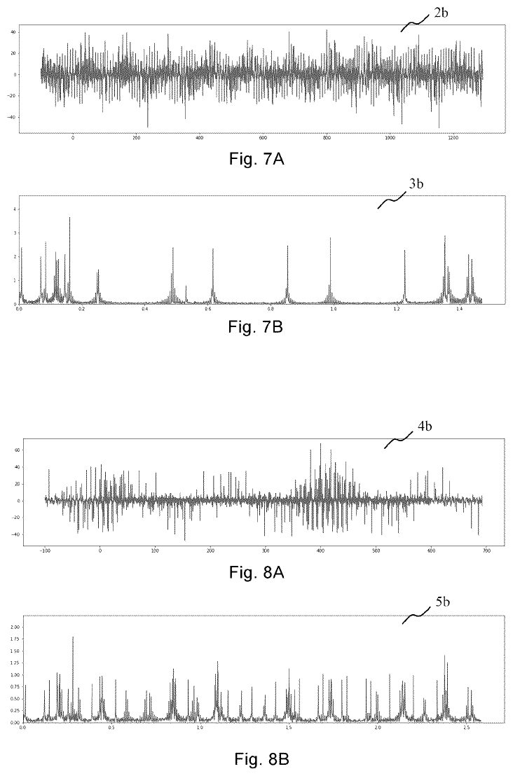

FIGS. 3A and 3B respectively show a time domain graph 2 and a frequency domain graph 3 of a vibration signal collected from a healthy rotary member at a high sampling frequency meeting the requirements of the sampling theorem; FIGS. 4A and 4B respectively show a time domain graph 4 and a frequency domain graph 5 of a vibration signal collected from an abnormal rotary member at the same sampling frequency as in FIGS. 3A and 3B. For comparison, FIGS. 5A and 5B respectively show a time domain graph 2a and a frequency domain graph 3a of a vibration signal collected from the healthy rotary member at an undersampling frequency equal to 1/11 of the sampling frequency in FIGS. 3-4; FIGS. 6A and 6B respectively show a time domain graph 4a and a frequency domain graph 5a of a signal collected from the abnormal rotary member at the same undersampling frequency as in FIGS. 5A and 5B; FIGS. 7A and 7B respectively show a time domain graph 2b and a frequency domain graph 3b of a vibration signal collected from the healthy rotary member at an undersampling frequency equal to 1/17 of the sampling frequency in FIGS. 3-4; FIGS. 8A and 8B respectively show a time domain graph 4b and a frequency domain graph 5b of a signal collected from the abnormal rotary member at the same undersampling frequency as in FIGS. 7A and 7B.

It can be seen from FIGS. 3-8 that there are differences between the signal frequency domain graphs of the healthy rotary member and the abnormal rotary member, at the high sampling frequency and also at the undersampling frequencies. Nevertheless, it is difficult to identify the true cause of a fault from multiple possible fault sources on the basis of the signal time domain graph and frequency domain graph at an undersampling frequency, because characteristic values and/or clear phenomena characterizing specific faults in the signal time domain graph and frequency domain graph of high-frequency sampling are lost in the signal time domain graph and frequency domain graph at this time due to aliasing. For this reason, fault identification methods known in the prior art which are suitable for signals sampled at high frequency are no longer suitable for undersampled signals.

Based on this, the present invention proposes acquiring at least two classes, for example three classes of different undersampled measurement data to serve as a basis for subsequent model training or abnormality identification.

According to one embodiment, the detection apparatus may comprise a single sensor. In this case, the single sensor may be configured to begin signal collection at a variable delay Δt relative to an occurrence time t₀ of a specific trigger event, and/or configured to have a variable undersampling frequency fₛ. In this way, different classes of undersampled measurement data may be collected by a single sensor. The specific trigger event may be set according to particular circumstances; for example, it may be each time an electric machine is started, each time an accelerator pedal or brake pedal is actuated, or each time a corresponding gear is changed to.

Additionally, in order to obtain at least two classes of undersampled measurement data, the delay Δt and/or the undersampling frequency fₛ used by the single sensor each time it is triggered by a trigger event may be different from the delay Δt and/or the undersampling frequency fₛ that was used on the previous occasion that triggering occurred.

According to an alternative embodiment, the detection apparatus may comprise two or more sensors. In this case, a different delay Δt and/or different undersampling frequency fₛ may be set for each sensor. In particular, the two or more sensors may be arranged at the same position, or adjacent positions.

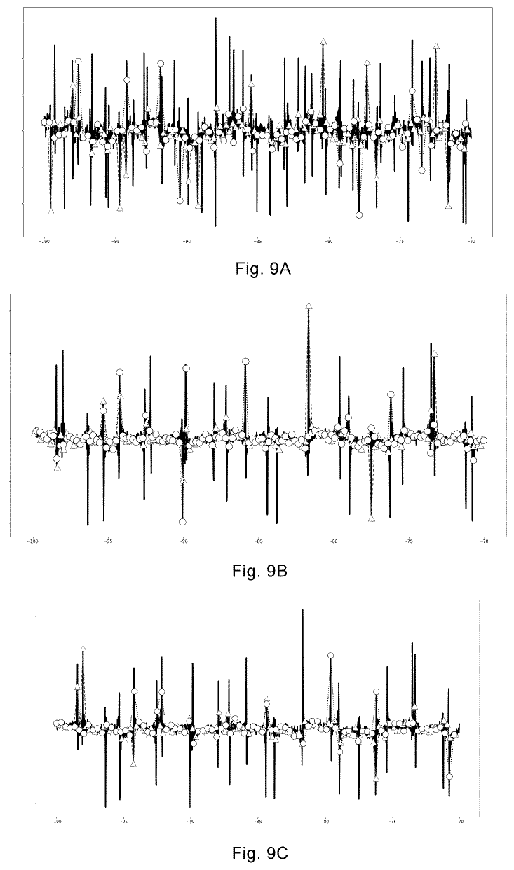

In an exemplary embodiment, a first class of undersampled measurement data in the at least two classes of undersampled measurement data is a signal collected at a sampling frequency fₛ₁ at a delay Δt₁ relative to an occurrence time t₀ of a specific trigger event, and a second class of undersampled measurement data in the at least two classes of undersampled measurement data is a signal collected at the sampling frequency fₛ₁ at a delay Δt₂ relative to the occurrence time t₀ of the specific trigger event, wherein Δt₁≠Δt₂. For this, see FIGS. 9A and 9B, wherein FIG. 9A shows a time domain graph of a signal collected from a healthy mechanical component, and FIG. 9B shows a time domain graph of a signal collected from an abnormal mechanical component. In FIGS. 9A and 9B, the continuous curve represents a signal collected at a sampling frequency fₛₕ meeting the requirements of the sampling theorem, the circles represent a signal collected at an undersampling frequency fₛ₁ at a first delay, and the triangles represent a signal collected at the undersampling frequency fₛ₁ at a second delay different from the first delay, wherein

$${f}_{s 1} = \frac{1}{11} \times {f}_{sh} .$$

In another exemplary embodiment, a first class of undersampled measurement data is a signal collected at a sampling frequency fₛ₁ at a delay Δt₁ relative to an occurrence time t₀ of a specific trigger event, and a second class of undersampled measurement data is a signal collected at a sampling frequency fₛ₂ at the delay Δt₁ relative to the occurrence time t₀ of the specific trigger event, wherein fₛ₁≠fₛ₂. For this, see FIG. 9C; FIG. 9C shows a time domain graph of a signal collected from an abnormal mechanical component. In FIG. 9C, the continuous curve represents a signal collected at a sampling frequency fₛₕ meeting the requirements of the sampling theorem, the circles represent a signal collected at a first undersampling frequency fₛ₁, and the triangles represent a signal collected at a second undersampling frequency fₛ₂ different from the first undersampling frequency fₛ₁, wherein

$${f}_{s 1} = \frac{1}{17} \times {f}_{sh} , and {f}_{s 2} = \frac{1}{11} \times {f}_{sh} .$$

In another exemplary embodiment, a first sampling time point of a first class of undersampled measurement data has a delay Δt₁ relative to an occurrence time t₀ of a specific trigger event, and the sampling frequency is fₛ₁, whereas a first sampling time point of a second class of undersampled measurement data has a delay Δt₂ relative to the occurrence time t₀ of the specific trigger event, and the sampling frequency is fₛ₂, wherein Δt₁≠Δt₂ and fₛ₁≠fₛ₂.

Furthermore, each class of undersampled measurement data may respectively comprise at least one set, in particular multiple sets of measurement data, wherein one set of undersampled measurement data may refer to a data stream collected by a sensor from the start of collection until the end of collection. As an example, if vehicle activation is taken to be a trigger event, then each activation of the vehicle triggers one collection of data to obtain one set of measurement data, so multiple activations of the vehicle can trigger the collection of multiple sets of undersampled measurement data; amongst these undersampled measurement data, undersampled measurement data having the same delay Δt and the same sampling frequency fₛ can form the same class of undersampled measurement data.

Next, optionally, in step S120, the at least two classes of undersampled measurement data acquired are separately divided into multiple samples; in particular, each set of measurement data in the at least two classes of undersampled measurement data is separately divided into multiple samples; a portion of the samples thereby obtained is used as training data, and another portion is used as test data, wherein the training data and the test data both include samples from at least two classes of undersampled measurement data.

As an example, the samples may be divided in such a way that each sample has a preset constant time length. Additionally, the samples may be divided in such a way that there is a preset time overlap between samples that are adjacent to each other in time, i.e. such that the end time point of the chronologically preceding sample falls after the start time point of the chronologically following sample, and such that the start time point of the chronologically following sample falls before the end time point of the chronologically preceding sample. In this way, it is possible to reduce or eliminate errors in the abnormality identification results caused by changes in the measurement data due to changes in the operating conditions of the mechanical apparatus or mechanical component.

Next, in step S130, a label is assigned to each sample separately. Labels may be “normal” and “abnormal”. Additionally, “abnormal” labels may include labels representing different types of abnormality and/or different abnormal regions and/or abnormality grades.

Next, in step S140, the samples acquired are used to train an abnormality identification model that is based on machine learning and used to identify an abnormality in a mechanical apparatus or mechanical component. If step S120 is omitted, each set of measurement data in the at least two classes of undersampled measurement data may be used directly to train the abnormality identification model.

In one example, the abnormality identification model is configured and trained to be able to identify whether an abnormality is present in a mechanical apparatus or mechanical component, as well as a type and grade of the abnormality. As an example, when applied to a rolling bearing, the abnormality identification model can determine whether an abnormality is present in the inner race, outer race, rollers or cage of the rolling bearing, as well as the severity of the abnormality.

According to an exemplary embodiment, the abnormality identification model is constructed using a characteristic-based classification algorithm. Such an abnormality identification model is suitable for situations in which it is possible to ascertain the causal relationship between the fault and the signal or the mechanism behind the fault or abnormality being monitored.

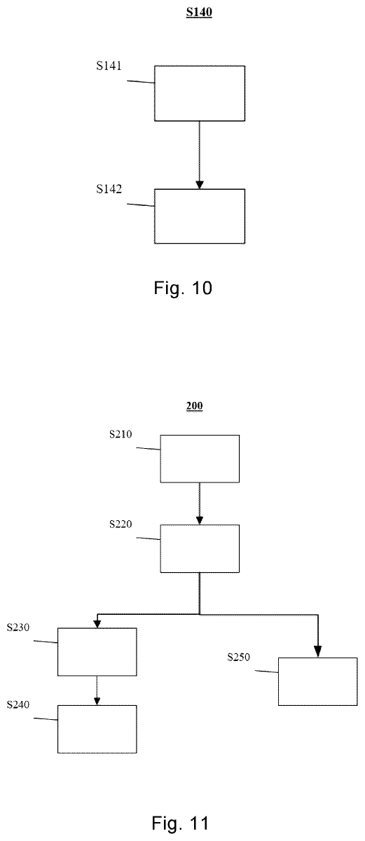

Step S140 further comprises (see FIG. 10): in step S141, each sample is subjected to characteristic extraction. The extracted characteristic may be determined on the basis of the monitored mechanical apparatus or mechanical component and/or the mechanism of the monitored fault, and comprises any one or more of the following characteristics:
i. frequency domain amplitude;
ii. frequency having significant amplitude;
iii. order of magnitude of the significant amplitude; and
iv. dispersion index of amplitude of time domain, first-order and second-order derivatives thereof, including the following of the dispersion index and/or first-order or second-order derivative:
   1. maximum value, average value and minimum value
   2. occurrence of a peak greater than a specific threshold within a fixed time, wherein the specific threshold is determined by an analytical model and finite element analysis;
   3. variance and standard deviation
   4. peak-to-peak ratio and peak-to-mean ratio
   5. statistical distribution kurtosis and skewness; and
v. significant time period in cepstrum; this is especially suitable for gearbox faults and some bearing faults.

In one example, the extracted characteristic may be determined by means of an expert system.

In general, if the state of the mechanical apparatus or mechanical component is already very dangerous, the amplitudes with the greatest order of magnitude or the overall dispersion index and overall mean value of the time domain might reflect this notably. Before such a situation develops, other statistical indices of the time domain and frequency domain characteristics can help to identify these potential abnormalities that are not yet very dangerous.

Next, in step S142, the extracted characteristics and labels thereof are inputted into the abnormality identification model to perform a supervised learning process, until the abnormality identification model is trained to meet the requirements.

According to another exemplary embodiment, the abnormality identification model is constructed using a deep learning algorithm. Such an abnormality identification model is suitable for situations in which it is not possible to know the causal relationship between the fault and the signal or the mechanism behind the fault or abnormality being monitored.

Data used to train such an abnormality identification model may be samples acquired from step S120, or each set of time domain or frequency domain measurement data itself. Moreover, the time length of samples used to train the abnormality identification model based on deep learning and the time length of the samples used to train the abnormality identification model based on a classification algorithm may be the same or different.

As an example, the abnormality identification model based on deep learning is constructed on the basis of a neural network, in particular, constructed on the basis of a convolutional neural network or a bidirectional LSTM (long short term memory) neural network. In particular, in the case of an abnormality identification model based on a bidirectional LSTM neural network, time sequence data may be used for training. In the case of an abnormality identification model based on a convolutional neural network, a pattern of time domain or frequency domain data may be used for training, e.g. a pattern of frequency domain data (e.g. spectrum) at a fixed rotation speed, a pattern of frequency domain data (e.g. Campbell diagram) within a rotation speed interval, or a pattern of a gradient diagram obtained from a Campbell diagram.

FIG. 11 shows a flow chart of a method 200 according to an exemplary embodiment of the present invention for identifying an abnormality in a mechanical apparatus or mechanical component.

In the method 200, in step S210, at least two classes of undersampled measurement data collected in or on a mechanical apparatus or mechanical component by a detection apparatus for example are acquired in real time, periodically, or with the aid of a data acquisition request, wherein all of the at least two classes of undersampled measurement data are different from one another in either one of or both of the following aspects: delay relative to occurrence time of a trigger event, and sampling frequency.

Optionally, in step S220, the at least two classes of undersampled measurement data acquired are separately divided into multiple samples.

Next, in step S230, the samples acquired are subjected to characteristic extraction. If step S220 is omitted, the at least two classes of undersampled measurement data may be subjected to characteristic extraction directly.

Next, in step S240, extracted characteristics are inputted into an abnormality identification model based on a classification algorithm, in order to output an abnormality monitoring result for the mechanical apparatus or mechanical component.

In another aspect, in step S250, the at least two classes of undersampled measurement data or the multiple samples are inputted into an abnormality identification model based on deep learning, in order to output an abnormality monitoring result for the mechanical apparatus or mechanical component.

Steps S210, S220 and S230 respectively correspond to steps S110, S120 and S141 described above. Thus, the above explanations of steps S110, S120 and S141 are applicable to steps S210, S220 and S230.

In one example, before steps S120 and S220, the measurement data acquired may be subjected to preprocessing, e.g. data normalization, cleaning and/or interpolation.

The method according to the present invention is not only able to identify faults which have already occurred in a mechanical apparatus or mechanical component and require corresponding repair, but also able to identify the presence of abnormalities in the mechanical apparatus or mechanical component in advance before they develop into actual faults, and can thus help the relevant personnel to make decisions regarding predictive maintenance.

Although some embodiments have been described, these embodiments are presented merely as examples, and not intended to limit the scope of the present invention. The attached claims and their equivalents are intended to cover all modifications, substitutions and changes falling within the scope and spirit of the present invention.

1. A method for identifying an abnormality in a mechanical apparatus or mechanical component, comprising:
i) acquiring at least two classes of undersampled measurement data collected in or on a mechanical apparatus or mechanical component, all of the at least two classes of undersampled measurement data being different from one another in either one of or both of the following aspects: delay relative to occurrence time of a trigger event, and sampling frequency; and
ii) based on the at least two classes of undersampled measurement data acquired, using an abnormality identification model to identify an abnormality in the mechanical apparatus or mechanical component, the abnormality identification model being based on machine learning and used for identifying an abnormality in the mechanical apparatus or mechanical component.

2. The method according to claim 1, wherein step ii) comprises:
a) subjecting the at least two classes of undersampled measurement data to characteristic extraction separately; and
b) inputting an extracted characteristic into a trained abnormality identification model based on a classification algorithm to obtain an abnormality identification result for the mechanical apparatus or mechanical component.

3. The method according to claim 1, wherein step ii) comprises:
inputting the at least two classes of undersampled measurement data into a trained abnormality identification model based on deep learning to obtain an abnormality identification result for the mechanical apparatus or mechanical component.

4. The method according to claim 1, wherein:
the at least two classes of undersampled measurement data are collected with the aid of a single sensor by: causing the single sensor to begin data collection at a variable delay in response to a trigger event, and/or causing the single sensor to collect data at a variable undersampling frequency.

5. The method according to claim 1, wherein:
the at least two classes of undersampled measurement data are collected with the aid of at least two sensors by: causing the at least two sensors to begin data collection at different delays in response to a trigger event, and/or causing the at least two sensors to collect data at different undersampling frequencies.

6. The method according to claim 1, further comprising the following step which is performed before step ii):
separately dividing the at least two classes of undersampled measurement data acquired into multiple samples, wherein there is a time overlap between samples that are adjacent to each other in time, and wherein in step ii), each sample is subjected to characteristic extraction separately or each sample is inputted into an abnormality identification model based on deep learning to obtain an abnormality identification result.

7. A method for training an abnormality identification model based on machine learning, the abnormality identification model being used to identify an abnormality in a mechanical apparatus or mechanical component, the method comprising:
acquiring at least two classes of undersampled measurement data collected in or on a mechanical apparatus or mechanical component, all of the at least two classes of undersampled measurement data being different from one another in either one of or both of the following aspects: delay relative to occurrence time of a trigger event, and sampling frequency; and
training an abnormality identification model on the basis of the at least two classes of undersampled measurement data acquired.

8. A computer apparatus, comprising a processor and a computer-readable storage medium communicatively connected to the processor, the computer-readable storage medium having a computer instruction stored therein, wherein a step of the method according to claim 1 is realized when the computer instruction is executed by the processor.

9. A computer program product, comprising a computer instruction, wherein a step of the method according to claim 1 is realized when the computer instruction is executed by a processor.

10. A detection apparatus, configured to collect measurement data at an undersampling frequency, the measurement data indicating an operating status of a mechanical apparatus or mechanical component, and the detection apparatus being communicatively connected to the computer apparatus according to claim 8, wherein:
the detection apparatus comprises a single sensor, the sensor being configured to begin data collection at a variable delay in response to a trigger event, and/or configured to have a variable undersampling frequency; or
the detection apparatus comprises at least two sensors, a first sensor of the at least two sensors being configured to begin data collection at a first delay in response to a trigger event, and a second sensor being configured to begin data collection at a second delay different from the first delay in response to a trigger event; and/or the first sensor being configured to have a first undersampling frequency, and the second sensor being configured to have a second undersampling frequency different from the first undersampling frequency.

11. A mechanical apparatus or mechanical component, comprising the detection apparatus according to claim 10.
